(19) United States
(12) Patent Application Publication
(10) Pub. No.: US 2010/0226384 A1
(43) Pub. Date: Sep. 9, 2010

(54) Method for reliable transport in data networks

(76) Inventors: Balaji S. Prabhakar, Palo Alto, CA (US); Berk Atikoglu, Stanford, CA (US); Mohammadreza Alizadeh Attar, Stanford, CA (US); Jia Shuo Yue, Stanford, CA (US)

Correspondence Address: LUMEN PATENT FIRM, 350 Cambridge Avenue, Suite 100, PALO ALTO, CA, 94306, US

(21) Appl. No.: 12/661,078

(22) Filed: Mar. 9, 2010

Related U.S. Application Data
(60) Provisional application No. 61/209,733, filed on Mar. 9, 2009.

(51) Int. Cl. H04L 12/56

(52) U.S. Cl. 370/412

(57) ABSTRACT

Rapid and reliable network data delivery uses state sharing to combine multiple flows into one meta-flow at an intermediate network stack meta-layer, or shim layer. Copies of all packets of the meta-flow are buffered using a common wait queue having an associated retransmit timer, or set of timers. The timers may have fixed or dynamic timeout values. The meta-flow may combine multiple distinct data flows to multiple distinct destinations and/or from multiple distinct sources. In some cases, only a subset of all packets of the meta-flow are buffered.

### CROSS-REFERENCE TO RELATED APPLICATIONS

This application claims priority from U.S. Provisional Patent Application 61/209,733 filed Mar. 9, 2009, which is incorporated herein by reference.

### FIELD OF THE INVENTION

The present invention relates generally to digital computer networks and data communications methods. More specifically, it relates to methods for improving data transport reliability in packet-switched computer networks.

### BACKGROUND OF THE INVENTION

As data centers grow in the number of server nodes and the operating speed of the interconnecting network, it has become challenging to ensure the reliable delivery of packets across the interconnection fabric. Moreover, the workload in large data centers is generated by an increasingly heterogeneous mix of applications, such as search, retail, high-performance computing and storage, and social networking.

There are two main causes of packets loss: (1) drops due to congestion episodes, particularly “incast” events, and (2) corruption on the wire due to increasing line rates. These packet losses cause timeouts at the transport and application levels, leading to a dramatic loss of throughput and an increase in flow transfer times and the number of aborted jobs.

The congestion episode termed “incast” or “fan-in” congestion leads to bursty losses and TCP timeouts. Essentially, incasting occurs when multiple sources simultaneously transfer data to a common client, overwhelming the buffers at the switch to which the client is connected. This phenomenon occurs with distributed storage and map-reduce type of applications. Studies have shown that incast causes a severe loss of throughput and vastly increases flow transfer times, making its prevention an extremely important factor in ensuring reliable packet delivery across data center interconnect fabrics.

There are two main approaches to combat the incast problem in data centers. One proposal for dealing with this problem in TCP/IP networks recommends reducing the duration of TCP timeouts using high resolution timers (HRTs), while another proposal advocates increasing switch buffer sizes to reduce loss events.

The use of HRTs is designed to drastically reduce the min-RTO (minimum retransmission timeout) to a few 100 μsecs from the typical value of 200 ms used in the WAN setting. The approach of reducing the value of the TCP's min-RTO to a few 100 μsecs has the effect of drastically reducing the amount of time a TCP source is timed out after bursty packet losses. However, high resolution timers are difficult to implement, especially in virtual-machine-rich environments. Reducing min-RTO requires making operating system-specific changes to the TCP stack. This imposes serious deployment challenges because of the widespread use of closed-source operating systems like Windows and legacy operating systems.

The other approach to the incasting problem is to reduce packet losses using switches with very large buffers. However, increasing switch buffer sizes is very expensive, and increases latency and power dissipation. Moreover, large, high-bandwidth buffers such as needed for high-speed data center switches require expensive, complex and power-hungry memories. In terms of performance, while they will reduce packet drops and hence timeouts due to incast, they will also increase the latency of short messages and potentially lead to the violation of service level agreements (SLAs) for latency-sensitive applications.

Accordingly, there remains a need for alternative solutions to the above-mentioned problems.

### SUMMARY OF THE INVENTION

In one aspect, the present invention provides a method for rapid and reliable data delivery that collapses individual flows into one meta-flow. This state-sharing leads to a very simple and cost-effective technique for making the interconnection fabric reliable and significantly improving network performance by preventing timeouts.

In contrast with other approaches that reduce the min-RTO (in the case of TCP), the approach of the present invention can be implemented in or below the virtualization layer. This allows a single timeout mechanism for all flows originating from a host. In contrast with other approaches that use large buffer sizes, the approach of the present invention can be viewed as moving the buffers out to the edge of the network. Buffering at the edge advantageously makes it possible to use very inexpensive and plentiful host memories or comparatively inexpensive and simply-structured memories in the network interface card (NIC). Another advantage is that combining multiple data flows into a smaller number of meta-flows compacts the state of the original flows. The reduction in flow state due to the compacting enables scalable solutions.

The present invention provides a method for reliable data transport in digital networks. The method includes combining multiple distinct data flows F1, . . . , Fk to form a single meta-flow F corresponding to an intermediate network stack meta-layer. Copies of all packets of the meta-flow are buffered using a common wait queue having an associated retransmit timer. A packet in the wait queue is retransmitted when the retransmit timer runs out and an ACK has not been received for the packet. The packet is removed from the wait queue when an ACK is received for the packet. Each ACK may correspond to a unique packet rather than being a cumulative ACK.

The method may be implemented, for example, in software as an operating system kernel module or, more preferably, in hardware as a network interface card. The meta-layer may be positioned between network stack layers 2 and 3. Combining the flows may include creating meta-layer packets from upper layer packets and passing the meta-layer packets to a lower layer for transmission. Combining the flows may include adding meta-layer packet headers to packets of the flows. The multiple distinct data flows may include flows to multiple distinct destinations and/or sources. In some embodiments, the flows are between servers in a data center. In some embodiments, only a subset of all packets of the meta-flow are buffered (and potentially retransmitted) at the transmitter. The subset may be chosen by sampling, or it may be chosen on a per-flow basis. In some embodiments, acknowledgements from an upper layer are used at the meta layer in place of meta-layer acknowledgements, thereby circumventing the need for any receiver acknowledgements at the meta layer.

Retransmitting the packet is preferably performed at most a predetermined number of times. In some embodiments, the retransmit timer has a timeout value less than 100 ms. Preferably, the timer has a timeout value less than 10 ms. In some embodiments, the retransmission timer has a timeout value that is in a continuous range. In other embodiments, the retransmission timer has a timeout value that is in a discrete range. In some embodiments, the retransmission timer has a timeout value that is dynamically adjusted based on measured round-trip time estimates and packet retransmission events. In some embodiments, the wait queue has multiple associated retransmit timers having multiple distinct timeout values.

The technique has various applications including Fiber Channel (FC), Fiber Channel over Ethernet (FCoE), Fiber Channel over IP (FCIP), TCP Offload Engines, Data Center networks, rapid retransmission of lost TCP packets, easy migration of virtual machine network state, and wireless mesh networks. In a simple fashion, the technique advantageously enables the acknowledgement of packet delivery in Ethernet, and hence in FCoE. It enables a vast improvement of flow completion (transfer) time by retransmitting packets faster than possible in standard TCP. It exploits the short round trip times in typical Data Center networks to maintain “common state” or “shared state” across flows and provides them rapid reliable transport. Most of all, it lends itself to easy, incremental deployment.

The technique advantageously gets rid of the need for link-level Pause that is needed by FCoE traffic. This standard addresses the large Storage Area Network market. A second major advantage is that losses due to packet corruption can be detected and recovered from using this technique. This feature is not currently present in existing Ethernet and hence in FCoE. Third, this technique opens a new approach to building cheaper TCP Offload Engines by introducing the idea of “common state” across flows in homogenous environments like Data Centers and Metro Ethernets. Fourth, it provides a way to enable rapid reliable transport by avoiding the large timeouts accompanying protocols like TCP. The technique can be implemented in hardware, software or firmware. It may be implemented as Ethernet drivers and as FPGA.

### BRIEF DESCRIPTION OF THE DRAWINGS

FIGS. 1A and 1B illustrate the structure and operation of meta-layer sender and receiver, respectively, according to an embodiment of the invention.

FIGS. 2A and 2B illustrate an example of a network architecture of a social networking data center which implements the techniques of the present invention.

FIG. 3 illustrates the structure and operation of a technique for processing packets at a meta-layer, according to an embodiment of the invention.

FIG. 4 is a flowchart outlining steps of a technique for processing packets at a meta-layer, according to an embodiment of the invention.

FIG. 5 is a schematic diagram illustrating how multiple flows F1, . . . , Fk are combined by a meta-layer sender to form a single meta-flow F and how meta-flows MF1, . . . , MFm are separated into individual flows F1, . . . , Fn by a meta-layer receiver, according to an embodiment of the invention.

FIGS. 6A, 6B, 6C illustrate how the techniques of the present invention may be implemented at various different intermediate network layers.

### DETAILED DESCRIPTION

Preferred embodiments of the present invention will now be described with reference to various drawing figures. These specific embodiments contain various details for the purposes of illustration only. Those skilled in the art will appreciate that the general principles of the present invention are not limited by these particulars, and many variations and alterations are possible and evident from these examples and associated teachings. One embodiment of the present invention provides a method which may be implemented as an incrementally deployable shim layer that handles reliable data transport over lossy (congestion and corruption losses) networks. In the present description, the term “shim layer” is also called the “meta-layer” (ML) or “Layer 2.5” (L2.5). The meta-layer refers to an intermediate layer in the network protocol stack. It can be implemented in subnetworks between any pair of ML or L2.5 peers. The term “flow” in the present description refers to a sequence of packets sharing a common queue and state at a layer (or meta-layer) in a network stack. A “meta-flow” refers to a flow at a meta-layer composed of one or more flows from a higher layer.

Embodiments of the present invention, herein called Rapid, Reliable Data Delivery (R2D2), are preferably implemented between network layers 3 and 2, thereby requiring no changes to either layer. In some embodiments, R2D2 strongly leverages the observation that data center interconnect fabrics are very homogeneous, i.e., (i) path lengths between hosts are small, typically 3 to 5 hops, (ii) round-trip-times across the fabric are very small, in the 100-400 μsecs range, and (iii) path bandwidths are uniformly high, with link speeds equal to 1 or 10 Gbps.

For the subsequent discussion, it is helpful to clarify the difference between R2D2 and L2.5. R2D2 is a technique for rapidly and reliably delivering L3 (especially TCP) packets. L2.5 is a conceptual shim layer at which R2D2 operates. As a layer, L2.5 may introduce its own encapsulation and header structure for data packets and acknowledgments. However, we shall see that encapsulation is not necessary when R2D2 is ensuring the reliable delivery of TCP packets.

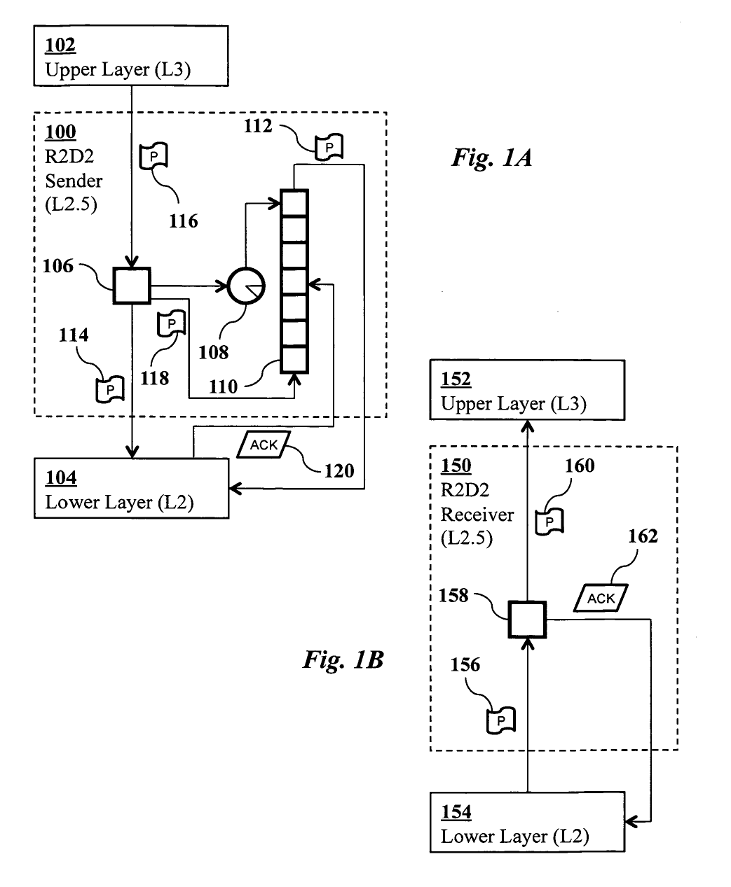

An overview of the R2D2 sender and receiver operation in one embodiment of the invention is illustrated in FIGS. 1A and 1B, respectively. FIG. 1A shows the R2D2 sender 100 positioned between an upper network layer 102 (e.g., L3) and lower network layer 104 (e.g., L2). An outbound packet 116 originating from upper layer 102 would normally be sent directly to lower layer 104 but instead passes through the intermediate meta-layer and is inspected by packet inspector 106. The packet inspector forwards the packet 114 to the lower layer 104 for transmission after adding meta-layer packet header information, thereby creating a meta-layer packet. The packet inspector 106 also makes a copy of the packet 116 and adds the copy 118 to the bottom of a wait queue 110. In addition, a retransmit timer 108 is started for the packet. If the timer 108 expires and the packet is still in the queue 110, then the packet is retransmitted by sending a copy of the packet 112 from the queue 110 to the lower layer 104. On the other hand, if the packet is received by its intended receiver and an ACK 120 from the receiver arrives, then the packet in the wait queue 110 is deleted. FIG. 1B shows the R2D2 receiver 150 positioned between an upper network layer 152 (e.g., L3) and lower network layer 154 (e.g., L2). Inbound packet 156 from lower layer 154 is intercepted by packet inspector 158. The packet 160 is delivered to upper layer 152, and an L2.5 ACK 162 is returned to the sender.

It should be noted that a copy of every upper-layer packet is stored in a common wait queue at the shim layer, Layer 2.5 (L2.5), regardless of the packet's destination. Consequently, a L2.5 meta-flow may include L3 flows to multiple distinct destinations. (Similarly, the L2.5 meta-flow may also include L3 flows from multiple distinct sources.) Normally, the packet will be acknowledged with ACK 162 by an R2D2 receiver module 158 when it reaches the egress interface of the fabric and the copy of the packet in the wait queue 110 is then dropped. However, if an ACK 120 isn't received at the wait queue 110 before a short timer 108 expires, the packet 112 is retransmitted. The homogeneity of the fabric allows R2D2 to (i) use a single wait queue for the packets of all upper-layer flows entering the fabric, and to (ii) use a common and short timer to retransmit unacknowledged packets in the wait queue.

Following are a few of the important features of R2D2 and related discussion.

### 1. Reliable, but not Guaranteed, Delivery.

R2D2 tries to ensure the reliable delivery of packets, but it does not guarantee them. Indeed, R2D2 retransmits an upper-layer packet at most a certain number of times before dropping the packet. Guaranteed packet delivery is ultimately left to upper-layer protocols like TCP, or the application.

### 2. State-Sharing.

In the preferred embodiment, there is exactly one wait queue into which all Layer 3 packets are placed, regardless of their destination. The size of the wait queue equals the total number of R2D2 transmitted packets that are yet to be acknowledged by their intended receivers. With an RTT of 1 ms and a line rate of 1 Gbps (or 10 Gbps), the wait queue is no more than 125 KB (respectively, 1.25 MB). This buffering is easy to provide either in the host or in the network interface card (NIC), depending on the implementation.

### 3. No Encapsulation at L2.5.

When producing an L2.5 ACK for a TCP packet, the R2D2 receiver includes the TCP/IP 5-tuple (IP src address, IP dest address, TCP src port, TCP dest port, TCP sequence number) corresponding to the TCP packet in the payload of the ACK packet. This 5-tuple uniquely identifies the TCP packet at the sender, so it can delete the copy stored in the wait queue. It is, therefore, not necessary for the R2D2 sender to generate unique packet-ids, and there is no need for encapsulation at L2.5. This enables R2D2-L2.5 to cover networks which include IP routing: a useful and important feature, since many large data centers use IP routers to connect L2 clusters. Of course, headers or tags will be needed if L2.5 were to cover other transport protocols (for example, UDP, FCoE).

### 4. No Change Required to Existing Network Stack

Advantageously, R2D2 does not require changes at L2 or L3. Furthermore, the hardware implementation, which can be implemented in a NIC, is OS-independent. By virtue of being a kernel module, the software version can be implemented for any modern OS without changing the network stack. For example, R2D2 could be implemented in Linux or in Windows (done using the NDIS API and the Windows Driver Kit). In most cases, however, the hardware implementation would be preferred, as it would be much faster.

### 5. Incremental Deployability.

It is possible to protect the packets of selected upper-layer flows using R2D2. Thus, R2D2 could be used to protect specific or all upper-layer flows between two given servers, all upper-layer flows between servers in the same subnet, upper-layer flows originating and terminating in the data center, etc. All that is needed is that both sides of a connection understand R2D2-L2.5.

### 6. Issues.

RTTs may not be homogeneous in practice because packets either pass through a router (which have deep buffers and L3 processing is involved) or through a deep-buffered switch. Thus, while RTTs are typically less than 300 μsecs, they may get larger than 5 ms. (We have observed ping latencies of 15-20 ms when the deep-buffered switches are used.) R2D2 may be enhanced to cope with this large range of RTTs by using a small number of additional retransmission timers. This extension makes R2D2 sensitive to path latencies.

### 7. Packet Corruption.

The 10 Gbps Ethernet standard requires a bit error rate of 10⁻¹² for all parts. Equipment manufacturers build devices with error rates of 10⁻¹⁵ or smaller, and optical transmission has extremely high quality. However, optical transducers at 10 Gbps and beyond are quite expensive and optical fiber installation on a large scale is expensive. So, for short distances, copper is very lucrative. However, copper is well-known to be error-prone and can be easily affected by EM radiation (the so-called “walkie-talkie” noise). Higher transmission power, shielding and complex error-correction codes are used to reduce corruption loss. Instead, if an end-to-end retransmission scheme can be found for diverse protocols, then copper could be made much more reliable. R2D2 could contribute to this effort.

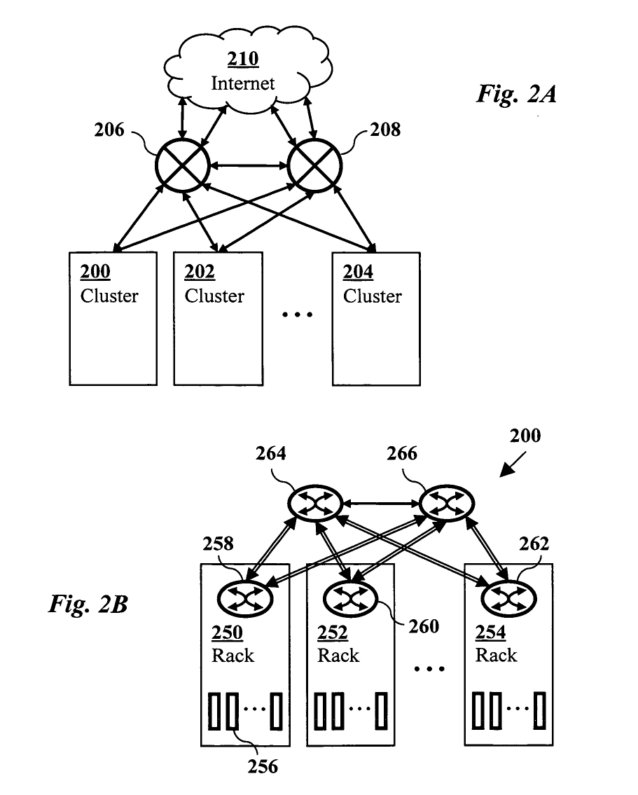

R2D2 has many applications in various different contexts including, for example, Fiber Channel (FC), Fiber Channel over Ethernet (FCoE), Fiber Channel over IP (FCIP), TCP Offload Engines, Data Center networks, rapid retransmission of lost TCP packets, easy migration of virtual machine network state, and wireless mesh networks. For illustrative purposes, following is an exemplary description of an application of R2D2 to a modern to data center environment. FIGS. 2A and 2B illustrate an example of a network architecture of a social networking data center. This data center typifies a certain class in which extensive data transfers take place, and illustrates the benefits and applications of R2D2. In this illustrative example, a company that operates the data center typically will have several data centers with similar topologies. The data center shown in FIG. 2A has several clusters (typically ranging from 4-8 clusters), including a first cluster 200, second cluster 202, and last cluster 204. The data center has a first data center router 206 and second data center router 208. Each of the clusters 200, 202, 204 is connected to both the first and second data center routers 206, 208 with 10 GbE connections. The two routers 206, 208, in turn, are connected to the Internet 210, also with 10 GbE external WAN connections.

FIG. 2B illustrates the architecture of cluster 200 (the other clusters 202, 204 have a similar architecture). The cluster 200 contains several hundred racks (e.g., 300-350 racks per cluster), including a first rack 250, second rack 252, and last rack 254. Each rack has several tens of servers (e.g., 40 servers per rack), such as server 256. Each rack also has a 1 GE top-of-the-rack (TOR) switch. In particular, rack 250 has switch 258, rack 252 has switch 260, and rack 254 has switch 262. Each of the TOR switches 258, 260, 262 is connected to two cluster core switches 264, 266 via several 1 GE connections. The servers in each rack are configured so that half the servers in a rack use one of the two core switches 264 and the other half of the servers use the other switch 266. The core switches 264, 266 have LOGE ports with 1G-to-10G port aggregators. They are connected to each other and to each of two data center routers 206, 208 through LOGE links. Thus, the cluster topology is hierarchical, with the routers 206, 208 connecting the clusters 200, 202, 204 and the LOGE switches 264, 266 in each cluster connecting the racks 250, 252, 254 to each other and to the routers.

In this exemplary data center, there are two major patterns of traffic: (i) in-cluster traffic from a server in one rack to a server in a different rack in the same cluster, and (ii) cluster-to-cluster traffic from a server in one cluster to a server in a different cluster. Internet control message protocol (ICMP) and TCP RTT latencies measured in the data center show homogeneity in network latencies. The in-cluster and cluster-to-cluster RTTs are small. The TCP RTTs, however, are noticeably different. This is attributed to the extra processing overhead needed for TCP in the network stack and depends on the load at the host. In summary, although the network fabric is, indeed, homogeneous, transport protocols at the hosts and host processing can make the end-to-end latency heterogeneous.

We now describe details of particular implementations of the R2D2 method described earlier in relation to FIGS. 1A and 1B. Those skilled in the art will recognize that these examples are only a few of the many possible implementations of the techniques of the invention, and that the specific data structures and other details of these embodiments may have numerous variations in other embodiments. For the purposes of description, first is described a simplified version of R2D2 that is implemented for a data center application with a single retransmission timeout value. This version is based on the assumption that the data center environment is homogeneous. Although this simplified implementation is effective under the assumption of network homogeneity, it is not so effective in an environment violating this assumption, such as when deep buffered switches (which introduce wide RTT variations) are used. To address this, a more preferred implementation contains multiple levels of timers, thereby allowing for adaptation to changes in the path RTT.

In these embodiments, R2D2 is implemented in software as a Linux kernel module. Hardware implementations would have analogous steps. The R2D2 kernel module is built on top of the Netfilter framework available in all Linux 2.6 kernels for intercepting and manipulating network packets. Netfilter provides a set of hooks inside the network stack which allow kernel modules to register a callback function associated with the hook. A registered callback is then invoked whenever a packet traverses the respective hook.

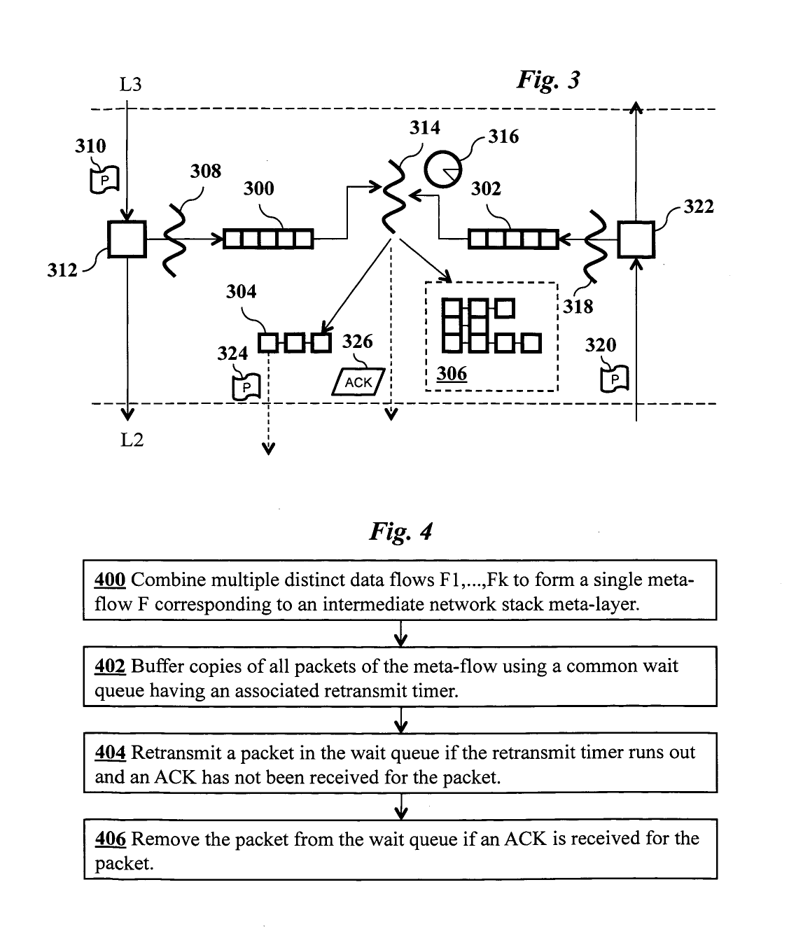

FIG. 3 illustrates the main architectural components of this implementation of R2D2. There are four main data structures: and outbound first-in-first-out (FIFO) queue 300, an inbound FIFO queue 302, a wait queue 304, and a hash table 306. An outbound L3 packet 310 is intercepted by module 312 and also passed on to L2. In addition, the outgoing Netfilter hook 308 populates outbound FIFO queue 300 with outbound packet 310 for R2D2 processing. Queue 300 is drained by the worker thread 314. The worker thread 314 is driven by a low resolution timer 316 with a period of 1 msec. Similar to the outbound FIFO queue 300, inbound FIFO queue 302 is populated by the incoming Netfilter hook 318, and stores inbound packets 320 intercepted by module 322 for R2D2 receiver processing. Inbound FIFO queue 302 is also drained by the worker thread 314. Packets that have been transmitted but not yet acknowledged by L2.5 ACKs are stored in wait queue 304. When a received L2.5 ACK matches a packet in the wait queue 304, the packet is deemed to be successfully transferred; it is then removed from the wait queue 304 and deallocated. Associated with the wait queue is a single timer which periodically checks whether a packet in the wait queue requires retransmission. If so, the packet 324 is retransmitted. The hash table 306 contains references to (un-ACKed) packets in the wait queue 304, to enable constant-time packet lookup and matching. In some embodiments, the ACKs correspond to unique packets and are not cumulative ACKs. It is also possible for the meta-layer to use upper layer ACKs in place of L2.5 ACKs, so that receivers need not generate L2.5 ACKs.

Embodiments of the present invention may also provide a technique for providing improved reliability of network packet delivery by quickly detecting packets dropped from congested buffers and quickly retransmitting the dropped packets. This helps improve the efficiency of data transport. By rapidly detecting lost packets and retransmitting them, this technique cuts down on the time to recover from losses, the need for costly congestion loss avoidance mechanisms like link-level pause, the detrimental effects of congestion spreading in pause-enabled networks and provides delivery guarantees (via per-packet acknowledgements) in Ethernet.

We now describe the above components in further detail.

### Capturing Packets

Netfilter hooks 308 and 318 capture all IP packets passing between layers 2 and 3. Outgoing packets 310 are captured after the IP processing is complete, and incoming packets 320 are captured before being sent to IP. Incoming L2.5 ACKs, however, are consumed inside the hook 318 and do not reach the IP layer. Each captured packet (more precisely, the sk_buff—an internal Linux data structure associated with that packet) is placed in the outgoing FIFO 300 or incoming FIFO 302 for processing by the worker thread 314. Threads are preferably used for processing rather than performing inline processing because inline processing increases packet latency. Similarly, it is preferred to use cloning (i.e., copying the fields of the sk_buff, but not the packet data itself)—rather than copying to store the information corresponding to the captured packets.

### R2D2 Processing

R2D2 processing takes place within the worker thread 314, which wakes up every 1 ms and performs the following operations in the order specified:

1. Process the packets in the outbound FIFO 300. Each packet is moved to the tail of the wait queue and a pointer to its location is stored in the hash table 306.
2. Process packets in the inbound FIFO queue 302. For an incoming TCP packet, an L2.5 ACK 326 is generated and sent back to the sender. For an incoming L2.5 ACK, the hash table 306 is checked to locate the packet in the wait queue corresponding to the ACK. This packet is discarded from the wait queue.
3. Retransmit packets. Check the wait queue 304 to identify packets that have been in the wait queue longer than the retransmission timeout value. If such a packet 324 is found, retransmit it.

### Processing Outgoing Packets

The worker thread 314 starts by processing packets in the outgoing FIFO queue 300, moving them to the wait queue 304 which is implemented as a linked list. A wait queue entry stores the packet's transmission timestamp, the number of retransmissions, the R2D2 key which uniquely identifies the packet, and a pointer to the packet itself. The 16-byte R2D2 key format, which is just one of many possible key formats, is presented in Table 1.

TABLE 1
R2D2 key format.

| Field | srcIP | dstIP | srcPort | dstPort | TCPseq |
|---|---|---|---|---|---|
| Size | 32 | 32 | 16 | 16 | 32 |

Field sizes are in bits.

The hash table 306 stores pointers to the location of packets in the wait queue 304. The hash table entry corresponding to a packet is accessible (via a hash function) using the packet's R2D2 key. This particular implementation uses a 2-left hash table to minimize the number of collisions. The hash table could be implemented in various other ways, of course, including use of content addressable memory, for example. There are special cases to consider, such as TCP retransmissions of a packet already held in the wait queue, and collisions. The details of how these cases are handled are provided in the pseudo-code.

### Processing Incoming Packets

The worker thread 314 processes the incoming FIFO 302 once the outgoing FIFO 300 is drained. An incoming packet can be either a TCP/IP data packet or an L2.5 ACK, so there are two cases to consider. (Note that R2D2 does not protect naked TCP ACKs; that is, TCP ACKs not attached to payloads. Recall that bits 100-102 in the TCP header are reserved and, hence, can be used by a data center operator to indicate L2.5 ACKs.)

### Case 1. Incoming TCP/IP Data Packets.

For each R2D2-protected TCP/IP data packet, the R2D2 receiver generates an L2.5 ACK. The L2.5 ACK packet structure is identical to a TCP/IP packet. However, in order to differentiate an L2.5 ACK from a regular TCP/IP packet, one of the reserved bits inside the TCP header may be set. The received packet's R2D2 key is obtained, and the corresponding fields inside the L2.5 ACK are set.

### ACK Aggregation.

Since the thread 314 processes incoming TCP/IP packets in intervals of lms, it is likely that some of the incoming packets are from the same source. In order to reduce the overhead of generating and transmitting multiple L2.5 ACKs, the L2.5 ACKs going to the same source are aggregated in an interval of the R2D2 thread. Consequently, an aggregated L2.5 ACK packet contains multiple R2D2 keys for acknowledging the multiple packets received from a single source.

### Case 2. Incoming L2.5 ACKs.

As mentioned in the previous paragraph, an L2.5 ACK packet can acknowledge multiple transmitted packets. For each packet acknowledged, the hash table 306 is used to access the copy of the packet in the wait queue. This copy and the hash table entry of the packet are removed.

It is possible that the L2.5 ACK contains the R2D2 key of a packet that is no longer in the wait queue 304 and the hash table 306. This can happen if a packet is retransmitted unnecessarily; that is, the original transmission was successful and yet the packet was retransmitted because an L2.5 ACK for the original transmission was not received on time. Consequently, at least two L2.5 ACKs are received for this packet. The first ACK will flush the packet and the hash table entry, and the second ACK will not find matching entries in the hash table or the wait queue. In this case, the second (and subsequent) ACKs are simply discarded. Such ACKs are called “unmatched ACKs.”

### Retransmitting Outstanding Packets

After the worker thread 314 finishes processing all the packets in the two FIFO queues 300 and 302, it checks the wait queue 304 for any packets that need to be retransmitted. A fixed retransmission timer may be used in a simple version of R2D2. The retransmission timeout value is preferably set to a value less than 100 ms, more preferably less than 10 ms. The timeout value may be set, for example, to 3 ms. The timeout value may be determined by the time it takes the various R2D2 threads to process the packet, generate the L2.5 ACK and to process the ACK. Plus, there is network and host latency. We upper bound these values by 3 ms in this embodiment. The value of the retransmission timeout value should take into consideration the R2D2 thread packet processing rate at the sender and, possibly, at the receiver as well. A hardware version of R2D2 could quite drastically reduce this timeout value and improve the performance.

If a packet which is ready to be retransmitted has exceeded its retransmission count (set to 10 in the current version), it is dropped from the wait queue, and its hash table entry is deleted. Otherwise, it is retransmitted and inserted at the tail of the wait queue.

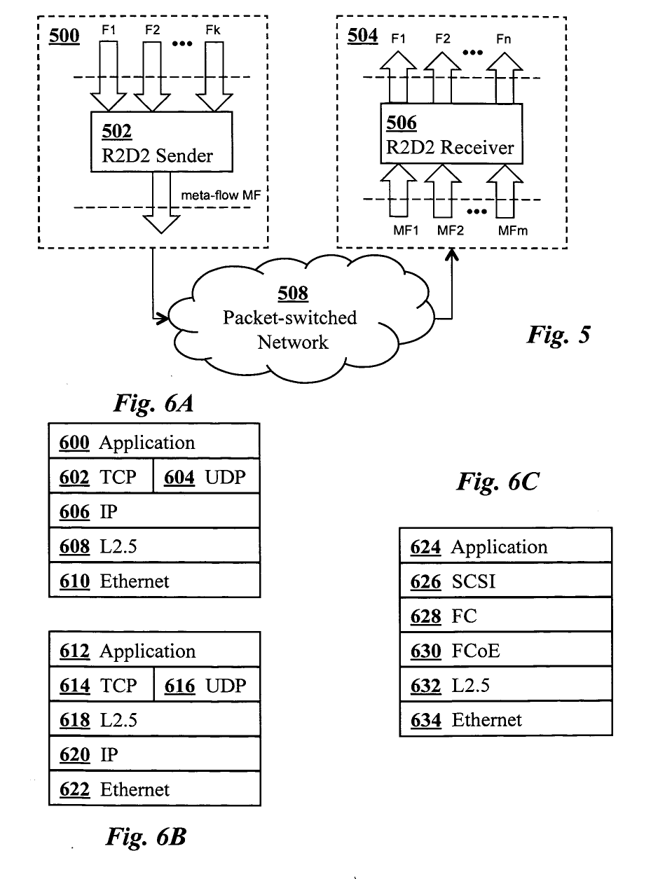

An outline of the R2D2 technique according to one embodiment of the invention is shown in the flowchart of FIG. 4. In step 400, multiple distinct data flows F1, . . . , Fk are combined to form a single meta-flow F corresponding to an intermediate network stack meta-layer. In step 402, copies of all packets of the meta-flow are buffered using a common wait queue having an associated retransmit timer. In step 404, a packet in the wait queue is retransmitted when the retransmit timer runs out and an ACK has not been received for the packet. In step 406, the packet is removed from the wait queue when an ACK is received for the packet. The schematic diagram of FIG. 5 illustrates how multiple L3 flows F1, . . . , Fk in device 500 are combined by R2D2 sender 502 to form a single meta-flow F at level L2. The meta-flow MF then is sent over a packet-switched network 508. Similarly, meta-flows MF1, . . . , MFm arriving from the internet at device 504 at L2 are separated into individual flows F1, . . . , Fn at L3 by R2D2 receiver 506.

### Revisiting the Homogeneity Assumption

The simple version of R2D2 described above, which uses a single fixed timer, may not perform well when servers are communicating across clusters, passing through router boundaries, or when there are deep-buffered switches, as deep-buffered switches can cause path latencies to significantly fluctuate.

R2D2 with Multiple Retransmission Timers

In a preferred embodiment, the simpler R2D2 technique described above is enhanced to cope with a wider range RTTs by using multiple retransmission timers, not just one. In the enhanced version, several levels of retransmission timeout values may be used. For example, in one specific impementation four levels are used with timeout values of 3 ms, 9 ms, 27 ms and 81 ms. These specific values, of course, are simply illustrative examples. It should also be noted that, as data centers evolve, the timeout values may well be smaller than these values. At any given time, the retransmission timeout value of a given TCP flow can be one of these four numbers. While this introduces per-destination state in R2D2, the actual cost of the implementation is reasonably small.

The selection of a timeout value for a TCP flow may be determined as follows. The selection is updated once in each cycle of the worker thread. It increases if R2D2 retransmits a small number of packets belonging to the flow in that cycle. It decreases if there is no retransmission of that flow's packets and the maximum RTT of an L2.5 packet belonging to that flow is small enough.

The use of multiple levels of timeout values in the enhanced version of R2D2 make it effectively handle congestion and significantly improve the goodput while heavily reducing unnecessary retransmissions.

Following is pseudocode to illustrate details of one implementation of an enhanced embodiment of R2D2. Specific details in this pseudocode, such as the particular timeout values, are merely examples.

We define the following constants.
BASE TIMER: amount of time a packet spends in the wait queue before being checked. Value: 3 ms.
TIMER FACTOR [i]: number of times, at level i, a packet is checked in the wait queue before being retransmitted. Value: [1 3 9 27].
FLOW MOVE UP: number of retransmissions a flow performs in a round before its level is incremented. Value: 3.
MAX RETRANS. number of times a packet is retransmitted before being dropped. Value: 10.

### Segment 1: Outbound Packet Processing.

for each packet in outgoing FIFO:

look up packet in hash table
if packet found:

// we have a hash collision
if same packet:

reset packet−>timestamp

else:

discard packet

end if

else:

put packet in wait queue
reset packet−>timestamp
create new hash table entry for packet

end if

end for

### Segment 2: Inbound Packet Processing.

for each packet in incoming FIFO:

if reserved bit is set:

// we have a L2.5 ACK
for each R2D2 key in ACK:

access hash table for packet
if found:

remove packet from wait queue
remove packet from hash table

end if
get RTT sample from ACK
packet−>flow−>maxRTT = max (packet−>flow−>maxRTT,
RTT sample)

end for

else:

// we have a TCP data packet
if L2.5 ACK to same destination does not exist:

create new L2.5 ACK
set reserved bit

end if
add R2D2 key to L2.5 ACK

end if

end for
send all L2.5 acks
// update flow-level correspondence
for each updated flow:

if flow−>retrans == 0 and

flow−>maxRTT < 0.5 * TIMER_FACTOR [flow−>level − 1] *
BASE_TIMER:
decrement flow−>level

end if
flow−>maxRTT = 0

end for

### Segment 3: Wait Queue Processing.

loop

obtain head of wait queue packet
if packet−>timestamp + BASE_TIMER < now:

// packet should be checked
pop packet from queue
increment packet−>cycleCount
if packet−>cycleCount >= TIMER_FACTOR
[packet−>flow−>level]:

send packet
increment packet−>flow−>retrans
if packet−>flow−>retrans >= FLOW_MOVE_UP:

increment packet−>flow−>level
packet−>flow−>retrans = 0

end if
increment packet−>retrans
if packet−>retrans >= MAX_RETRANS:

discard packet

else:

push packet into queue

end if

end if

else:

terminate loop

end if

end loop

### Implementation

Various choices may be made in designing R2D2 for particular implementations, such as in the Linux kernel. Most of the choices are guided by the desire for simplicity and stability. Various optimizations involving the data structures and thread execution which can further reduce CPU and network overhead may also be used.

### Retransmission Timeout Values.

The timeout values at the various levels may be static (e.g., set to one of several fixed values, as described above) or dynamic. The values may be selected from a discrete range of values or a continuous range of values. The timeout values may be dynamically adjusted based on measured round-trip time estimates and packet retransmission events. Dynamically adapting the base-level (3 ms) RTO according to the TCP algorithm leads to a noticeable but not large performance improvement over fixed timeout levels. Moreover, there is a regularity to data centers, especially in the RTT values, that favors the simplicity of the fixed timeout levels. In general, however, there may be situations where dynamic adjustment of one or more timeout values is preferred in some implementations.

### Single Retransmission Timer.

When there is homogeneity and the RTTs are small, R2D2 with a single retransmission timer performs quite well. The simplicity of this version is very appealing, and it may be used in the context of large switch interconnect fabrics, where the RTT across the fabric is quite small and there is homogeneity in path lengths and bandwidths.

### Parameters and Data Structures.

R2D2 does not have many parameters. The only important parameters are the retransmission timeout values which have been discussed above. Another parameter is the maximum number of times a packet is retransmitted. This may be set, for example, to 10. We have found this to be a conservative number: in all the tests we have conducted, R2D2 (with multiple timeout levels) does not retransmit a packet more than thrice. Of course, other values of this parameter are possible as well.

Software vs. Hardware/Firmware.

Preferred embodiments of R2D2 turn off standard stateless offloading features like large send offload (LSO). This offload is known to be very useful and can reduce CPU overheads by as much as 30% at high speeds. However, that would mean that the kernel version of R2D2-L2.5 would see large TCP byte-streams and not TCP/IP packets passing through it. To infer packet boundaries from the byte-streams, while not impossible, is certainly overhead intensive and defeats the purpose of offloading in the first place.

For many applications, it would be most preferable to implement R2D2 in NIC hardware. In such implementations, its essential statelessness would align well with other stateless offloads, such as LSO and checksum. As compared to full TCP offload engines (TOEs), which are stateful and have serious detractors, R2D2 is easy to implement and leaves TCP flow handling to the kernel. A NIC implementation also makes it easy to provide additional functions in the R2D2-L2.5 module, such as packet pacing, resequencing received packets, and eliminating duplicate packet deliveries to Layer 3.

In preferred embodiments, segmentation offloading is disabled because it needs to capture TCP packet meta-data in kernel. Of course, a NIC-level implementation would not need to do this. (Disabling segmentation offloading hurts the performance of R2D2 in terms of CPU overhead and goodput, especially at 10 Gbps, but the effect appears slight.) The TCP timestamp option is also turned off since the R2D2-L2.5 retransmission of a packet uses its initial timestamp, and this may violate the requirement that timestamps on successive packets arriving at a TCP receiver must be increasing.

### Deployment: Selective Protection of Flows

R2D2 can be incrementally deployed, i.e., set up to protect only a set of chosen flows. Moreover, it be incrementally deployed in a network, and it can also provide reliable delivery as a service to a specified set of applications or tenants in a multi-tenanted data center. Thus, in some embodiments, only a subset of all packets of the meta flow are buffered at the transmitter (and potentially retransmitted). The subset may be chosen by sampling, or it may be chosen on a per-flow basis.

One important category of packets not protected by R2D2 is naked (i.e., no payload) TCP ACKs. Naked TCP ACKs are small in size, so the chance they may be dropped is small. Secondly, a single such ACK is not critical for achieving high performance because, if a naked TCP ACK is dropped, subsequent TCP ACKs can compensate for the dropped ACK due to the cumulative nature of TCP ACKing.

There are multiple ways of protecting packets or flows with R2D2:

Flows may be protected in a subnet specified by an IP prefix. Protecting flows originating and terminating within a subnet (for example, a cluster in a data center) requires very little effort. Note that R2D2 does not require any application-level awareness in this setup.

TCP flows may be protected on specific TCP ports to protect TCP flows belonging to specific applications. The application uses the specified TCP port(s) for its flows.

TCP flows can be protected using the DiffServ field in the IP header. For flows within a data center, the DiffServ field can be used to designate R2D2 protection status. This allows applications and servers to dynamically change the status of a flow between “protected” and not.

As illustrated in FIGS. 6A, 6B, 6C, the techniques of the present invention may be implemented at various network layers. For example, FIG. 6A shows an embodiment in which the L2.5 meta-layer 608 is positioned just above the Ethernet layer 610, with the IP layer 606, TCP 602 and UDP 604 layer, and Application Layer 600 above. FIG. 6B shows an embodiment in which the L2.5 meta-layer 618 is positioned just above the Ethernet layer 622 and the IP layer 620, with the TCP 614 and UDP 616 layer, and Application Layer 612 above. FIG. 6C shows an embodiment in which the L2.5 meta-layer 632 is positioned just above the Ethernet layer 634, with the FCoE layer 630, FC layer 628, small computer system interface (SCSI) layer 626, and Application Layer 624 above.

In conclusion, the R2D2 method is a rapid and reliable data delivery algorithm which operates at a shim layer between Layers 2 and 3 to effect state-sharing across multiple upper-layer flows at Layer 3 into one (or a few) meta-flows at Layer 2.5. Software implementations have a small CPU overhead, comparable to that of the HRT algorithm, and the technique does not induce too much network overhead in the form of L2.5 ACKs. It is robust to different network speeds (1G and 10G), network equipment (different switches) and traffic conditions. The techniques of the present invention have various applications including Fiber Channel (FC), Fiber Channel over Ethernet (FCoE), Fiber Channel over IP (FCIP), TCP Offload Engines, Data Center networks, rapid retransmission of lost TCP packets, easy migration of virtual machine network state, and wireless mesh networks. They may also be used to cope with corruption losses over the physical (especially copper) medium.

1. A method for reliable data transport in digital networks, the method comprising:
a) combining multiple distinct data flows F1, . . . , Fk to form a single meta-flow F corresponding to an intermediate network stack meta-layer;
b) buffering copies of packets of the meta-flow using a common wait queue having an associated retransmit timer;
c) retransmitting a packet in the wait queue if the retransmit timer runs out and an ACK has not been received for the packet;
d) removing the packet from the wait queue if an ACK is received for the packet.

2. The method of claim 1 wherein the multiple distinct data flows comprise flows to multiple distinct destinations.

3. The method of claim 1 wherein the multiple distinct data flows comprise flows from multiple distinct sources.

4. The method of claim 1 wherein the method is implemented in software as an operating system kernel module.

5. The method of claim 1 wherein the method is implemented in hardware as a component of a network interface card.

6. The method of claim 1 wherein the meta-layer is between layers 2 and 3.

7. The method of claim 1 wherein combining the flows comprises creating meta-layer packets from upper layer packets and passing the meta-layer packets to a lower layer for transmission.

8. The method of claim 1 wherein combining the flows comprises adding meta-layer packet headers to packets of the flows.

9. The method of claim 1 wherein retransmitting the packet is performed at most a predetermined number of times.

10. The method of claim 1 wherein the flows are between servers in a data center.

11. The method of claim 1 wherein the timer has a timeout value less than 100 ms.

12. The method of claim 1 wherein the timer has a timeout value less than 10 ms.

13. The method of claim 1 wherein the wait queue has multiple associated retransmit timers having multiple distinct timeout values.

14. The method of claim 1 wherein the timer has a timeout value selected from a continuous range of values.

15. The method of claim 1 wherein the timer has a timeout value selected from a discrete range of values.

16. The method of claim 1 wherein the timer has a timeout value dynamically adjusted based on measured round-trip time estimates and packet retransmission events.

17. The method of claim 1 wherein the ACK is received for the packet corresponds to a unique packet and is not a cumulative ACK.

18. The method of claim 1 wherein acknowledgements from upper layer are used at the meta layer in place of meta layer acknowledgements.

19. The method of claim 1 wherein buffering copies of packets of the meta-flow comprises buffering only a subset of all packets of the meta-flow.
